(19) United States
(12) Patent Application Publication
(10) Pub. No.: US 2013/0285785 A1
(43) Pub. Date: Oct. 31, 2013

(54) LOW TEMPERATURE CO-FIRED CERAMIC DEVICE AND A METHOD OF MANUFACTURING THEREOF

(71) Applicant: Nano and Advanced Materials Institute Limited, Hkust (HK)

(72) Inventors: Yu Wang, Hung Hom (HK); Lianxing He, Hung Hom (HK); Zehui Yong, Hung Hom (HK); Helen L. W. Chan, Hung Hom (HK)

(21) Appl. No.: 13/861,531

(22) Filed: Apr. 12, 2013

Related U.S. Application Data
(60) Provisional application No. 61/686,850, filed on Apr. 13, 2012.
(60) Provisional application No. 61/686,851, filed on Apr. 13, 2012.

(51) Int. Cl. H01F 27/28; H01F 41/04

(52) U.S. Cl. CPC H01F 27/2804; H01F 41/041
USPC 336/200; 29/602.1

(57) ABSTRACT

The invention relates to a low temperature co-fired ceramic (LTCC) device comprising a first dielectric layer having a first electrode, a second dielectric layer having a second electrode, wherein the first dielectric layer and the second dielectric layer are arranged so that the first electrode and the second electrode overlap with each other to form a coupled structure, wherein the two electrodes are asymmetric in configuration, with the first electrode being smaller than the second electrode in at least one dimension. The invention also relates to a method in preparing such a LTCC composition.

### CROSS REFERENCE TO RELATED APPLICATIONS

This application claims priority to U.S. Provisional Application No. 61/686,850 filed on Apr. 13, 2012, and U.S. Provisional Application No. 61/686,851 filed on Apr. 13, 2012, the contents of which are incorporated herein by reference.

### FIELD OF THE INVENTION

The invention relates to a low temperature co-fired ceramics (LTCC) device and the method of manufacturing thereof Particularly, the invention relates to a LTCC device with an improved process tolerance and the method of manufacturing such device.

### BACKGROUND OF THE INVENTION

Low temperature co-fired ceramics (LTCC) is being frequently used as means for radio frequency integrated circuit (RFIC) fabrication. In a LTCC device, elements of electrodes are formed in each of the different layers representing various kinds of electronic components such as internal resistors, capacitors, inductors, and transmission lines. Coupled striplines are widely used as electrodes in RFIC designs to perform the functions of directional couplers, power dividers, and baluns, etc. In a laminated LTCC structure, broadside-coupled striplines are preferred due to their large coupling factors and easy designs. However, it is known that stacking faults are easily resulted from the conventional lamination process in which minor misalignments may usually occur between the adjacent layers and therefore causing variation to the designate coupling factor.

A conventional broadside-coupled striplines are composed of a line component formed in a top dielectric layer and another line component formed in a bottom layer. The two line components should be identical and overlaying in parallel with each other. While the coupling coefficient is mainly determined by the overlapping area, layer misalignment is a critical source of error. According to U.S. Pat. No. 6,873,221, an “L-shaped” coupled-line segment has been used to minimize the degradation effects of registration errors. Such an “L-shaped” segment misaligned along the x-coordinate would generally operate to differentially dispose only one half of the line component of segment to positions previously occupied by other differential line components (e.g., those line segment components originally disposed along the x-coordinate). As line segment becomes nominally misaligned along the y-coordinate, the remaining half of differential components of line segment (e.g., those line segment components originally disposed along the y-coordinate) would be disposed to positions previously occupied by the remaining half of line components. Accordingly, the total differential displacement along the x-coordinate and y-coordinate generally would be expected to substantially minimize or otherwise reduce the degradation of performance experienced by a LTCC device employing broadside-coupled striplines. However, when the “L-shaped” segment is misaligned along the x-coordinate or the y-coordinate, only one half of the segment remains totally coupled while the other half still suffers from registration errors. In addition, the misalignments may not occur solely in one direction. An “L-shaped” segment will do nothing on the displacements along a direction between x-coordinate and y-coordinate. Furthermore, any multilayer production process typically demonstrates alignment tolerances. To the extent that state of the art tolerances for LTCC layer-to-layer alignment currently are on the order of about 20 μm, with printed circuit board alignment tolerances being as high as about 75 μm, there exists a need for a system and method to minimize degradation effects attributed to misalignment during the production of a LTCC device such as multilayer balun devices.

### SUMMARY OF THE INVENTION

In accordance with a first aspect of the present invention, there is provided a low temperature co-fired ceramic device comprising:
a first substrate layer having a first electrode;
a second substrate layer having a second electrode;

wherein the first substrate layer and the second substrate layer are arranged such that the first electrode and the second electrode at least partially overlap with each other to form a coupled structure; and,

wherein the first electrode is smaller than the second electrode in at least one dimension.

In an embodiment of the first aspect, the first electrode overlaps the second electrode at a centre region of the second electrode.

In an embodiment of the first aspect, the first electrode and the second electrode are of substantially identical shape.

In an embodiment of the first aspect, the first electrode and the second electrode are in a corresponding meandering shape.

In an embodiment of the first aspect, the first electrode and the second electrode are in a corresponding spiral shape.

In an embodiment of the first aspect, at least one of the first substrate layer and the second substrate layer is a dielectric layer.

In an embodiment of the first aspect, the first substrate layer and the second substrate layer are both dielectric layers of a same material.

In an embodiment of the first aspect, the first substrate layer and the second substrate layer are both dielectric layers of different materials.

In an embodiment of the first aspect, the first substrate layer and the second substrate layer is fabricated using low temperature co-fired ceramics technology or standard multilayer printed circuit board technology.

In an embodiment of the first aspect, the device further comprises a plurality of the first substrate layer and the second substrate layer to form a multi-layered (or laminated) structure.

In accordance with a second aspect of the present invention, there is provided a method of preparing a low temperature co-fired ceramic device, the method comprising:

a. providing a first electrode on a first substrate layer;

b. providing a second electrode on a second substrate layer;

c. arranging the first substrate layer and the second substrate layer so that the first electrode and the second electrode are at least partially overlapping with each other to form a coupled structure; and,

wherein the first electrode is smaller than the second electrode in at least one dimension.

In an embodiment of the second aspect, the method further comprising a step of providing a plurality of the first substrate layer and the second substrate layer to form a multi-layered or laminated structure.

### BRIEF DESCRIPTION OF THE DRAWINGS

The present invention will be more clearly understood from the following detailed description taken in conjunction with the accompanying drawings, in which:

FIG. 1 is a top view of a prior art as disclosed in U.S. Pat. No. 6,873,221 showing a linear broadside-coupled line;

FIG. 2 is a top view of another prior art as disclosed in U.S. Pat. No. 6,873,221 showing a broadside-coupled line folded into an “L-shape”;

FIG. 3 is a perspective view showing a section of conventional aligned broadside-coupled striplines;

FIG. 4 is a perspective view showing a section of conventional misaligned broadside-coupled striplines;

FIG. 5 is a perspective view showing a prior art laminated balun transformer with broadside-coupled striplines as disclosed in U.S. Pat. No. 6,873,221.

FIG. 6 is an exploded perspective view showing the internal structures of the laminated balun transformer of FIG. 5.

FIG. 7 is a perspective view showing a section of asymmetric broadside-coupled striplines in accordance with the present invention;

FIG. 8 is a perspective view showing a section of misaligned asymmetric broadside-coupled striplines of FIG. 7;

FIG. 9 is a perspective view of a section of asymmetric broadside-coupled striplines of FIG. 7 configured in a meandering shape;

FIG. 10 is a perspective view of a section of asymmetric broadside-coupled striplines of FIG. 7 configured in a spiral shape;

FIG. 11 is a graph showing the S11 parameters of laminated balun transformers employing symmetric broadside-coupled striplines at each frequency; and

FIG. 12 is a graph showing the S11 parameters of laminated balun transformers employing asymmetric broadside-coupled striplines at each frequency.

### DESCRIPTION OF THE PREFERRED EMBODIMENTS

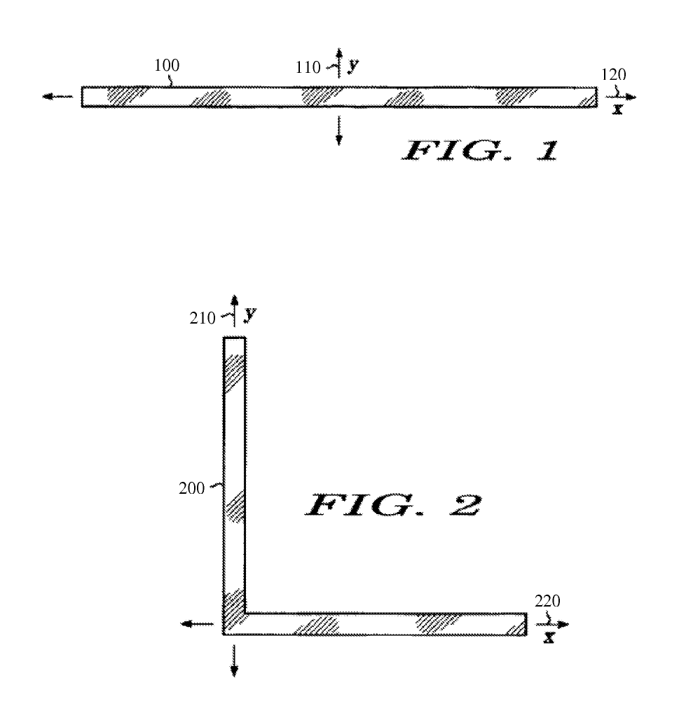

FIG. 1 representatively depicts a prior art broadside-coupled stripline as disclosed in U.S. Pat. No. 6,873,221. The straight coupled-line segment 100 whose misalignment is along the x-coordinate 120 would generally operate to dispose differential components of line segment 100 in positions previously occupied by other differential line components. Accordingly, the net differential displacement along the x-coordinate 120 generally would not be expected to substantially degrade performance of an electronic device such as a balun device employing the coupled-line segment 100 as illustrated in FIG. 1. This would not be the case, however, for differential displacement along the y-coordinate 110. As line segment 100 is nominally misaligned along the y-coordinate 110, differential components of line segment 100 are disposed in positions previously not occupied by other differential line components. Accordingly, net differential displacement along the y-coordinate 110 generally would be expected to effectively degrade performance of a balun employing the coupled-line segment 100 as illustrated in FIG. 1.

FIG. 2 representatively illustrates another prior art which is a broadside-coupled line being folded into an “L-shape” as disclosed in U.S. Pat. No. 6,873,221. The “L-shaped” coupled-line segment 200 misaligned along the x-coordinate 220 would generally operate to differentially dispose only one half of the line components of segment 200 to positions previously occupied by other differential line components (e.g., those line segment components originally disposed along the x-coordinate 220). As line segment 200 becomes nominally misaligned along the y-coordinate 210, the remaining half of differential components of line segment 200 (e.g., those line segment components originally disposed along the y-coordinate 210) would be disposed to positions previously occupied by the remaining half of line components. Accordingly, the total differential displacement along the x-coordinate 220 and y-coordinate 210 generally would be expected to substantially minimize or otherwise reduce the degradation of performance experienced by a balun employing the coupled-line segment 200 as illustrated in FIG. 2 where the vector direction of misalignment may not be effectively predetermined However, when the “L-shaped” segment is misaligned along the x-coordinate or y-coordinate, only one half of the segment remains totally coupled, while the other half still suffers from registration errors. Additionally, the misalignments may not occur solely in one direction. An “L-shaped” segment will do nothing on the displacements along a direction between x-coordinate and y-coordinate. Furthermore, any multilayer production process typically demonstrates alignment tolerances.

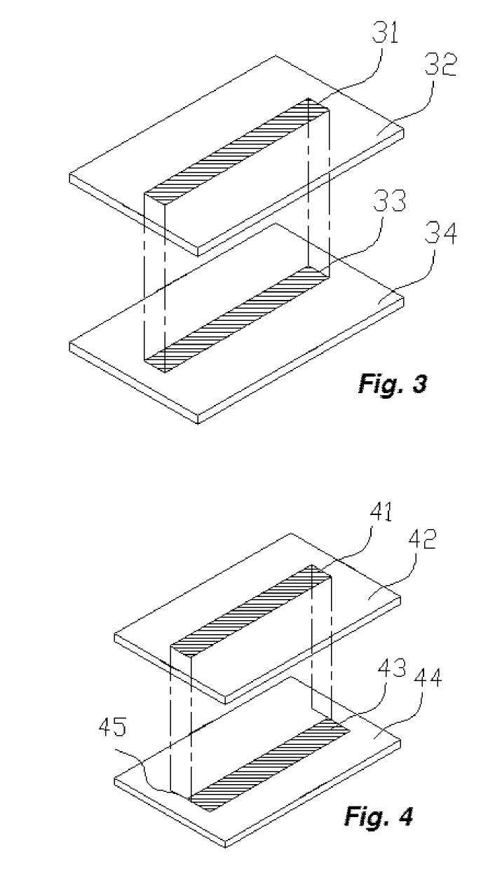

FIG. 3 shows a perspective view of a section of conventional broadside-coupled striplines. As shown in this figure, the coupled striplines comprise a line component 31 formed in a dielectric layer 32, and another line component 33 of substantially identical shape as line component 31, formed in parallel with and overlapped line component 31, in a dielectric layer 34. While the coupling coefficient of the LTCC device is mainly determined by the overlapping area, layer misalignment is a critical source of error. The misalignment is demonstrated in FIG. 4 which shows a section of misaligned broadside-coupled striplines. The striplines comprise a line component 41 formed in a dielectric layer 42, and another line component 43 of substantially identical shape as line component 41, formed in a dielectric layer 44. The line component 41 is in parallel with, but not accurately below the line component 43. It is shown in the figure that the overall coupled structure of line components 41 and 43 has misaligned along the line 45 such that the width of overlapping area is reduced. In practice, the offset 45 is a registration error which may be caused in collation or stacking process. The coupling coefficient of the broadside-coupled striplines of FIG. 4 would be changed when compared to the broadside-coupled striplines of FIG. 3 without the registration error.

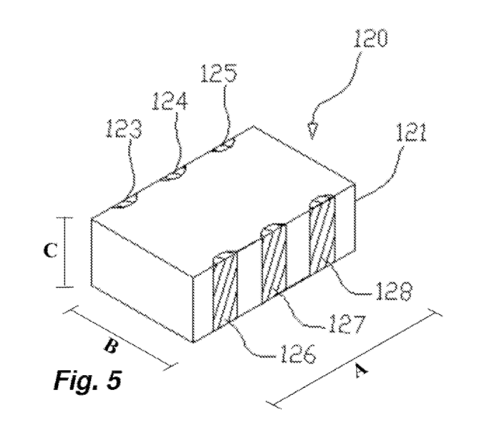

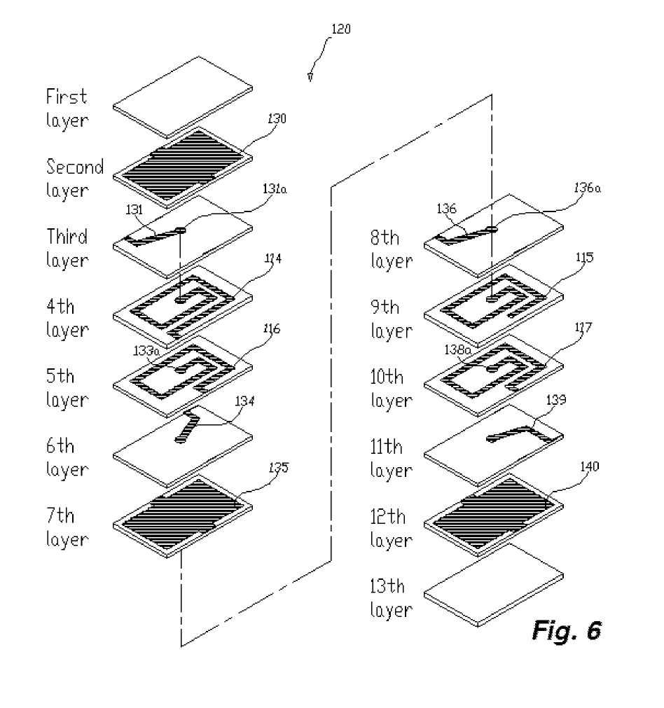

FIG. 5 shows a conventional laminated balun transformer disclosed in U.S. Pat. No. 7,183,872, which is a typical LTCC device with broadside coupled striplines. FIG. 6 shows an exploded view of the conventional laminated balun transformer of FIG. 5 illustrating the internal structures of the balun transformer. Referring to FIG. 5, the conventional laminated balun transformer 120 is composed of a rectangular hexahedral dielectric block 121 and a plurality of external electrodes 123 to 128 formed on two opposite sides of the dieletric block 121, each of which is set as a terminal such as an unbalancd terminal, a balanced terminal, or a ground terminal For example, an external electrode 123 is set as a terminal for non-connection, external electrodes 124 and 127 are set as a terminal for a ground, external electrodes 125 and 128 are set as a terminal for input/output of a balanced signal, and an external electrode 126 is set as a terminal for input/output of unbalanced signal. Referring to FIG. 6, the dielectric block 121 is composed of a plurality of dielectric sheets laminated using an LTCC method. On the plurality of dielectric sheets laminated there formed a first ground electrode 131a which is connected to the external electrodes 124 and 127 for a ground, the first stripline 114 having a length of λ4 A and having one end connected to the external electrode 126 for input/output of the unbalanced signal, the third stripline 133 formed in parallel with the first stripline 114, having a length of λ/4 and having both ends connected respectively to the external electrode 125 for input/output of the balanced signal and the external electrode 127 for a ground, a second ground electrode 131b connected to the external electrodes 124 and 127 for a ground, the second stripline 115 having a length of λ/4 and having one end connected to the first stripline 114 via the external electrode 123 and other end opened, the fourth stripline 117 formed in parallel with the second stripline 115 and having both ends connected respectively to the external electrode 127 for a ground and the external electrode 128 for input/output of the balanced signal, and a third ground electrode 131 connected to the external electrodes 124 and 127 for a ground, sequentially in a downward direction. Additionally, on the plurality of dielectric sheets laminated there may also be formed lead electrodes 132a to 132d for connecting the first to fourth striplines 114 to 117 to respective external electrodes 123 to 128, and via holes 133a to 133d for electrically connecting the lead electrodes 132a to 132d to corresponding striplines 114 to 117 on other layers. Such laminated balun is vulnerable to registration errors when symmetric broadside-coupled striplines are applied, i.e., when the striplines 114 and 116, 115 and 117 are of the same width respectively.

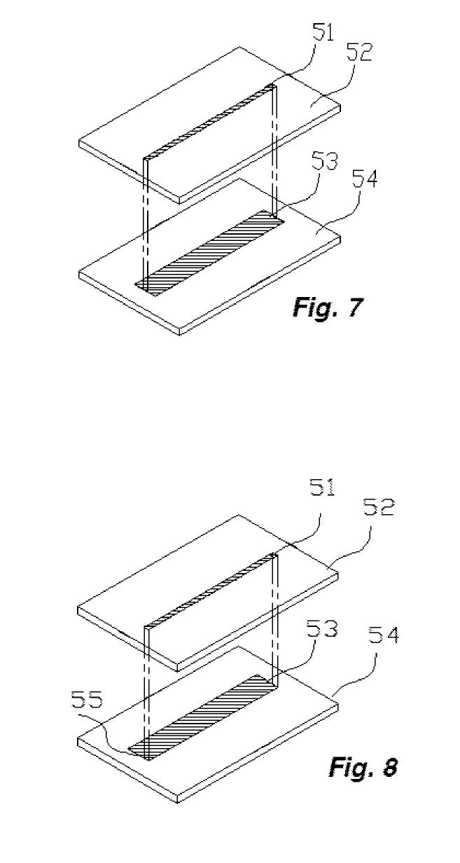

Turning to the LTCC device of the present invention, FIG. 7 shows an embodiment which includes at least a pair of substrate layers having electrodes in the form of asymmetric broadside-coupled striplines arranged in an aligned configuration. The asymmetric broadside-coupled striplines include a narrower line component 51 in any shape, formed in a first dielectric layer 52, and another line component 53 of a substantially identical shape as line component 51 but with a wider line width, formed in a second dielectric layer 54. The first dielectric layer 52 and the second dielectric layer 54 are positioned so that the line component 51 is in parallel to and is overlapped with line component 53 to form a coupled structure. While the coupling coefficient of the LTCC device is mainly determined by the overlapping area, the line width of the narrower line component 51 is a determinant It is shown in FIG. 7 that the line components 51 and 53 are overlapped so that the overlapping area is at a centre region of the line component 53.

FIG. 8 shows the asymmetric broadside-coupled striplines of FIG. 7 arranged in a misaligned configuration. It is shown that line components 51 and 53 are again overlapped with each other, with the overlapping area located at a region slightly offset from the centre region of the line component 53. Although there is an overall misalignment along the line 55 as shown in FIG. 8, the overlapping area is not reduced and but instead being the same as the overlapping area of the asymmetric broadside-coupled striplines of FIG. 7.

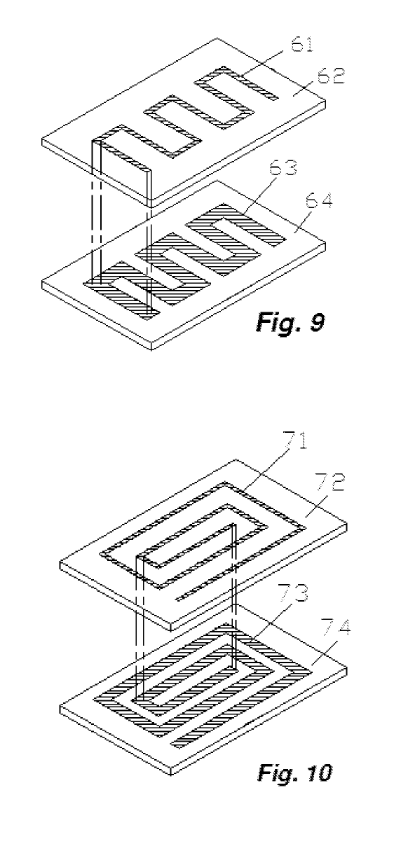

FIG. 9 shows another embodiment of the present invention which includes a section of asymmetric broadside-coupled striplines formed in a meandering shape. FIG. 10 shows a further embodiment of the present invention which includes a section of asymmetric broadside-coupled striplines formed in a spiral shape. It is shown from the figures that line components 61 and 63 of FIG. 9 and line components 71 and 73 of FIG. 10 are of substantially identical shape, respectively, but with the width of the line component 61 being shorter than the width of the line component 63, and the width of the line component 71 being shorter than the width of the line component 73. The two components of each figure are overlapped each other. It should be understood that the shape of the line components is not limited to linear shape, meandering shape and spiral shape, but any other shapes are also possible without departing from the spirit of the present invention.

Alternatively, the asymmetry of the broadside-coupled striplines can be provided by having at least one dimension of any one of the line components being smaller than that of the other line component.

The two dielectric layers can be made of any microwave dielectrics, with the same dielectric material or two different dielectric materials. The dielectric layer and the broadside-coupled striplines can be fabricated using LTCC technology, standard multilayer printed circuit board technology or another other suitable fabrication methods.

The LTCC device as described above can be applied in the design of electric devices such as laminated balun transformers, stepped filters, duplexers, power dividers, directional couplers and microwave devices employing broadside coupled-striplines.

It is yet a further embodiment of the present invention which includes a plurality of the pair of substrate layers to form a multi-layered (laminated) structure.

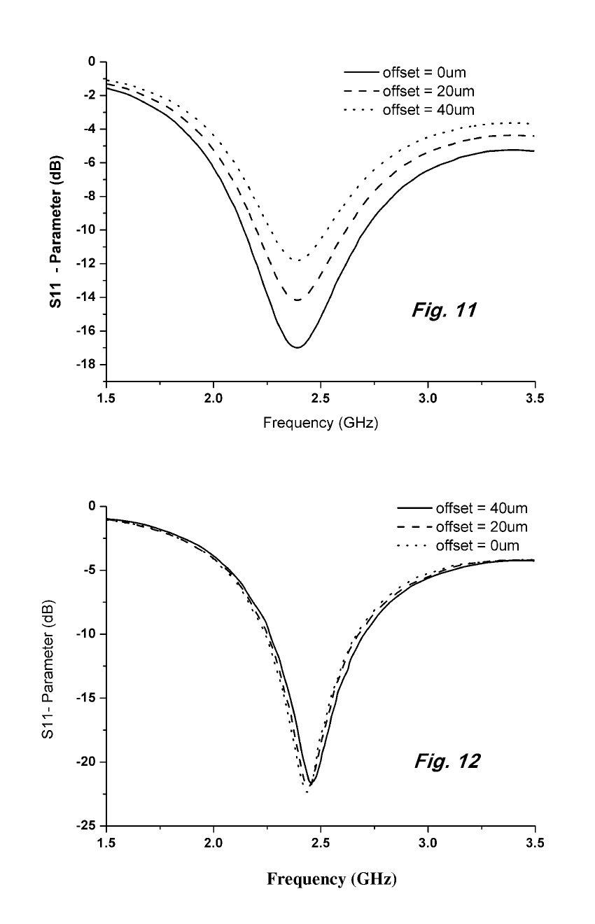

FIG. 11 shows a graph demonstrating the curves which represent the S11 parameters of laminated balun transformers employing symmetric broadside-coupled striplines at each frequency. In the microwave technology, S-parameters refer to the scattering matrix, i.e. a mathematical construct that quantifies how microwave energy propagates through a multi-port network. The S11 as illustrated in FIG. 11 refers to the ratio of signal that reflects from port one for a signal incident on port one. The curves correspond to models with different magnitude of misalignments. All of the curves are simulation results given by commercial softwares (e.g. FHSS) using FEM (finite element method). The device includes a dielectric block which is of the same shape as that shown in FIG. 5, with a length A=2 mm, width B=1.25 mm, height C=0.91 mm. The three external electrodes of unbalanced/balanced ports are all of impedance 50 ohm The internal structure of the device is of the same configuration as described in FIG. 6. The block is composed of a first layer to a 13th layer which are all made of a ceramic material with a dielectric constant of 7.9. Each of the layer having a height of t=70 μm and are laminated one by another. The first to the fourth striplines 114 to 117 are all made of silver with a thickness of 7 μm. The striplines are formed in spiral shapes with a total length of 7 mm When the striplines pairs of 114 and 116, 115 and 117 are formed into symmetric broadside-coupled striplines, each of them has a line width of 0.105 mm. For each of the curves as shown in FIG. 11, each of the striplines 114 and 116, 115 and 117 offsets from their corresponding counterpart by 0 μm, 20 μm and 40 μm, respectively. The centre frequency of the three models has all been set at 2.42 GHz. The S11 parameter of the balun with no misalignments (i.e. offset=0 mm) can approach as low as −17 dB, while the S11 parameters of baluns with offsets (i.e. 20 μm and 40 μm) can only reach a higher value of −13.5 dB and a −11 dB, respectively. As a conclusion, registration errors may cause an adverse effect to S11 parameter of laminated balun transformer employing symmetric broadside-coupled striplines.

FIG. 12 is a graph demonstrating the curves which represent the S11 parameters of laminated balun transformers employing asymmetric broadside-coupled striplines at each frequency. Again, different curves correspond to different magnitudes of misalignments, namely 0 μm, 20 μm and 40 μm. All of the curves are simulation results given by commercial softwares (e.g. FHSS) using FEM (finite element method). The device includes a dielectric block which is of the same shape as that shown in FIG. 5, with a length A=2 mm, width B=1.25 mm, height C=0.91 mm. The three external electrodes of unbalanced/balanced ports are all of impedance 50 ohm. The internal structure of the block is of the same configuration as that shown in FIG. 6. The block is composed of a first layer to a 13th layer which are all being made of a ceramic material with a dielectric constant of 7.9. Each of the layer having a height t=70 μm, laminated one by another. The first to the fourth striplines 14 to 17 are all made of silver with a thickness of 7 μm, formed in spiral shapes with a length of 7 mm. When the striplines 114 and 116, 115 and 117 are all formed into asymmetric broadside-coupled striplines, each of them having a top line width of 0.05 mm, a bottom line width of 0.16 mm. For each respective curve, the striplines 114 and 116, 115 and 117 are misaligned with their corresponding counterpart by offsets of 0 μm, 20 μm and 40 um, respectively. The centre frequency of the three models has all been set at 2.42 GHz. The S11 parameter of the balun with no misalignments (i.e. offset=0 mm) can approach as low as −22.5 dB, while the S11 parameters of baluns with offsets (i.e. 20 μm and 40 μm) between asymmetric broadside-coupled striplines are very similar, which are of −22 dB and −21 dB, respectively. As a conclusion, registration errors have little effects on S11 parameter of laminated balun transformer employing asymmetric broadside-coupled striplines.

The results as shown in FIGS. 11 and 12 demonstrated that, by replacing the conventional symmetric coupled striplines with asymmetric coupled striplines within the block of the ceramic of a LTCC device, a better tolerance against electrode misalignments and therefore a more stable coupling coefficient can be achieved during the lamination process regardless of registration errors.

The present invention also relates to a method of preparing a LTCC device. One embodiment of the method includes the steps of providing a first broadside-coupled stripline on a first dielectric layer, providing a second broadside-coupled stripline on a second dielectric layer, arranging the two dielectric layers so that the first broadside-coupled striplines and the second broadside-coupled striplines are overlapping with each other to form a coupled structure, with the first broadside-coupled stripline having a width shorter than the width of the second broadside-coupled stripline. The method may further includes a step of providing a plurality of the first and second dielectric layers to form a multi-layered (laminated) structure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

It should also be understood that certain features of the invention, which are, for clarity, described in the context of separate embodiments, may also be provided in combination in a single embodiment. Conversely, various features of the invention which are, for brevity, described in the context of a single embodiment, may also be provided or separately or in any suitable subcombination.

1. A low temperature co-fired ceramic device comprising:
a first substrate layer having a first electrode;
a second substrate layer having a second electrode;
wherein the first substrate layer and the second substrate layer are arranged such that the first electrode and the second electrode at least partially overlap with each other to form a coupled structure; and,
wherein the first electrode is smaller than the second electrode in at least one dimension.

2. The low temperature co-fired ceramic device of claim 1, wherein the first electrode overlaps the second electrode at a centre region of the second electrode.

3. The low temperature co-fired ceramic device of claim 1, wherein the first electrode and the second electrode are of substantially identical shape.

4. The lower temperature co-fired ceramic device of claim 4, wherein the first electrode and the second electrode are in a corresponding meandering shape.

5. The low temperature co-fired ceramic device of claim 4, wherein the first electrode and the second electrode are in a corresponding spiral shape.

6. The low temperature co-fired ceramic device of claim 1, wherein at least one of the first substrate layer and the second substrate layer is a dielectric layer.

7. The low temperature co-fired ceramic device of claim 7, wherein the first substrate layer and the second substrate layer are both dielectric layers of a same material.

8. The low temperature co-fired ceramic device of claim 7, wherein the first substrate layer and the second substrate layer are both dielectric layers of different materials.

9. The low temperature co-fired ceramic device of claim 1, wherein the first substrate layer and the second substrate layer is fabricated using low temperature co-fired ceramics technology or standard multilayer printed circuit board technology.

10. The low temperature co-fired ceramic device of claim 1, further comprising a plurality of the first substrate layer and the second substrate layer to form a multi-layered (or laminated) structure.

11. A method of preparing a low temperature co-fired ceramic device, the method comprising:
a. providing a first electrode on a first substrate layer;
b. providing a second electrode on a second substrate layer;
c. arranging the first substrate layer and the second substrate layer so that the first electrode and the second electrode are at least partially overlapping with each other to form a coupled structure; and,
wherein the first electrode is smaller than the second electrode in at least one dimension.

12. The method of preparing a low temperature co-fired ceramic device of claim 12, further comprising a step of providing a plurality of the first substrate layer and the second substrate layer to form a multi-layered or laminated structure.
